(19) United States
(12) Patent Application Publication
(10) Pub. No.: US 2008/0156253 A1
(43) Pub. Date: Jul. 3, 2008

(54) Bookmark

(76) Inventor: Darren Wilcox, Miami, FL (US)

Correspondence Address: JOHN L. JAMES, P.O. BOX 2025, MARIETTA, GA, 30061-2025, US

(21) Appl. No.: 11/649,075

(22) Filed: Jan. 3, 2007

(51) Int. Cl. B42D 9/00

(52) U.S. Cl. 116/234

(57) ABSTRACT

A bookmark has an elongate body with front and rear surfaces. An arm, attached to the body, has a first arm portion extending a preselected distance from the front surface and a second arm portion connected to the first arm portion and slanting toward the front surface. The second arm portion has a front and rear surfaces with the rear surface facing toward the front surface of the body. A spacer attached to the rear surface of the second arm portion extends toward the front surface of the body. A marker is attached to the front surface of the second arm portion.

### TECHNICAL FIELD OF THE INVENTION

This invention relates generally to a bookmark, and, more particularly, to an enhanced bookmark having a clip and device for holding a place in a book for easy return thereto.

### BACKGROUND OF THE INVENTION

Bookmarks are typically used when reading a book to mark a place in the book when reading is paused so that the place is easily found when reading is resumed. A strip of plain paper can serve as a simple bookmark, but stiff paper and plastic coated or laminated paper works better because the increased thickness makes opening the book to the marked page easier. A problem with these simple bookmarks is that, because they are not attached to the book, the bookmark can fall out of the book. Accordingly, it can be appreciated that it would be highly desirable to have a bookmark that attaches to the book.

Some bookmarks have clips to attach the bookmark to the book so that the bookmark does not fall out of the book. Some clips attach to the spine of the book while others attach to several pages pressed together. These bookmarks typically are made thin to fit flat and unobtrusively in the book to imitate the thickness of a paper or laminated bookmark. While such a flat bookmark is unobtrusive, it does not force the book to open at the marked page. Accordingly, it will be appreciated that it would be highly desirable to have a bookmark that has thickness or otherwise makes opening the book to the marked page easier.

### SUMMARY OF THE INVENTION

The present invention is directed to overcoming one or more of the problems set forth above. Briefly summarized, according to one aspect of the present the invention, a bookmark comprises an elongate body having a front and rear surfaces. An arm, attached to the body, has a first arm portion extending a preselected distance from the front surface and a second arm portion connected to the first arm portion and slanting toward the front surface. The second arm portion has front and rear surfaces with the rear surface facing toward the front surface of the body. A spacer is attached to the rear surface of the second arm portion and extends toward the front surface of the body. A marker is attached to the front surface of the second arm portion.

The second arm portion is resiliently attached to the first arm portion forming a spring clip for attaching the bookmark to the pages or binder of a book. Attaching a first portion of the spacer to the rear surface of the second arm portion spaces a distal portion of the spacers from the front surface creating a gap for pages of the book or the binder. When configured as a pointer, the marker points to a selected portion of a page of the book.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a perspective view of a preferred embodiment of a bookmark according to the present invention.

FIG. 2 is a side view of the bookmark of FIG. 1.

### DETAILED DESCRIPTION OF THE PREFERRED EMBODIMENTS

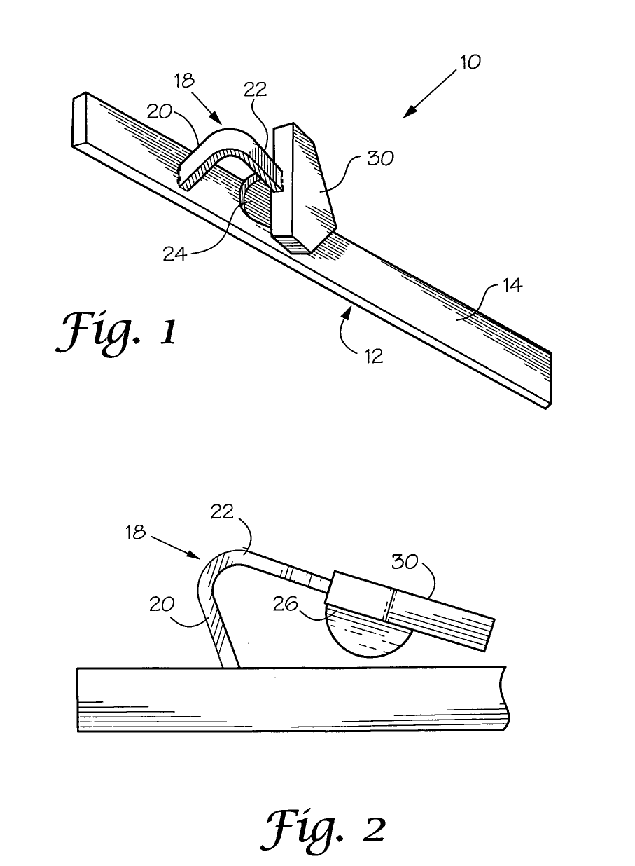

Referring to FIGS. 1-2, a bookmark 10 attaches to a book and has an effective thickness sufficient for causing the book to open to the marked page. Bookmark 10 has an elongate body 12 with a front surface 14 and a rear surface 16. Bookmark 10 is preferably formed of an injection molded plastic material, such as polypropylene for example, but can be formed of metal, or other materials as well.

An arm 18 is attached to the body 12 and is preferably integrally molded therewith. The arm 18 has a first portion 20 that extends a preselected distance from front surface 14, and a second portion 22 that is connected to first portion 20 and slants toward front surface 14. First arm portion 20 is spaced from a top end of the elongated body 12, so that, when used, the top end protrudes from the book while the first arm portion is disposed between the pages of the book. First arm portion 20 preferably forms an acute angle with the top portion of body 12, but can be perpendicular thereto or form an obtuse angle therewith. The second arm portion 22 has a front surface and a rear surface with the rear surface facing toward the front surface 14 of the body 12. Preferably, second arm portion 22 is resiliently attached to first arm portion 20 and is biased by the slant toward front surface 14 to clip or clamp pages between front surface 14 and second arm portion 22. Alternatively, other attachment methods or connections can be used provided the second arm portion 22 retains its spring bias.

A spacer 24 is attached to the rear surface of the second arm portion 22 and extends toward front surface 14 of body 12. Spacer 24 has a first portion 26 that is attached to the rear surface of second arm portion 22, and a distal portion 28 that is spaced from front surface 14. The distal portion 28 is preferably spaced from front surface 14 creating a gap therebetween for receiving pages of the book. The distal portion 28 preferably has an arcuate configuration with a semicircular configuration being most preferred. An arcuate configuration aids the insertion and removal of book pages from the gap between distal portion 28 and front surface 14.

A marker 30 is attached to the front surface of the second arm portion 24. When attached to the top or side edge of a book page, marker 30 can point to a paragraph on the page. Thus, the marker 30 is preferably configured as a pointer, or more preferably as an arrowhead.

It can now be appreciated that a bookmark for marking a position in a book for return to that position at a later time has been presented. One example of a bookmark according to the present invention was injection molded as a unitary structure using a polypropylene material. The body was approximately

$$4 \frac{1}{4}$$

inches long,

$$\frac{3}{8}$$

inches wide and

$$\frac{1}{8}$$

inches thick. The first arm portion was

$$\frac{5}{8}$$

inches high,

$$\frac{1}{8}$$

inches wide and disposed 1 inch from the top end of the body. It slanted or angled toward the top end of the body at an angle of approximately 70 degrees. The second arm portion was also

$$\frac{1}{8}$$

inches wide and

$$1 \frac{1}{8}$$

inches long. The spacer had a diameter of about

$$\frac{9}{16}$$

inches with a gap of about

$$\frac{1}{16}$$

inches. The pointer was pentagonal in configuration like home plate on a baseball field with the pointed end pointing away from the top end of the body. It was approximately

$$\frac{15}{16}$$

inches wide across the top and

$$\frac{5}{8}$$

inches down the middle.

While the invention has been described with particular reference to the preferred embodiments, it will be understood by those skilled in the art that various changes may be made and equivalents may be substituted for elements of the preferred embodiments without departing from invention. For example, while it is contemplated that the bookmark have a narrow body to conserve material, a wide body could be used to provide an area for product identification or advertising

As is evident from the foregoing description, certain aspects of the invention are not limited to the particular details of the examples illustrated, and it is therefore contemplated that other modifications and applications will occur to those skilled in the art. Also, there is no set shape or orientation for the teeth. It is accordingly intended that the claims shall cover all such modifications and applications as do not depart from the true spirit and scope of the invention.

### ELEMENT LIST

| | |
|---|---|
| 10 | bookmark |
| 12 | elongate body |
| 14 | front surface |
| 16 | rear surface |
| 18 | arm |
| 20 | first arm portion |
| 22 | second arm portion |
| 24 | spacer |
| 26 | first portion |
| 28 | distal portion |
| 30 | marker |

What is claimed is:

1. A bookmark, comprising:
an elongate body having a front surface and a rear surface;
an arm attached to said body, said arm having a first arm portion extending a preselected distance from said front surface and a second arm portion connected to said first arm portion and slanting toward said front surface, said second arm portion having a front surface and a rear surface, said rear surface facing toward said front surface of said body;
a spacer attached to said rear surface of said second arm portion and extending toward said front surface of said body; and
a marker attached to said front surface of said second arm portion.

2. A bookmark, as set forth in claim 1, wherein said second arm portion is resiliently attached to said first arm portion.

3. A bookmark, as set forth in claim 1, wherein said spacer has a first portion attached to said rear surface of said second arm portion and a distal portion spaced from said front surface.

4. A bookmark, as set forth in claim 3, wherein said distal portion is spaced from said front surface creating a gap therebetween.

5. A bookmark, as set forth in claim 3, wherein said distal portion is arcuate.

6. A bookmark, as set forth in claim 3, wherein said distal portion is semicircular.

7. A bookmark, as set forth in claim 1, wherein said marker is configured as a pointer.

8. A bookmark, as set forth in claim 1, wherein said marker is configured as an arrowhead.

9. A bookmark, as set forth in claim 1, wherein said first arm portion is spaced from a top end of said body.
